(19) United States
(12) Patent Application Publication
(10) Pub. No.: US 2008/0159578 A1
(43) Pub. Date: Jul. 3, 2008

(54) Boundary microphone

(75) Inventors: Hiroshi Akino, Machida-shi (JP); Shioto Okita, Machida-shi (JP); Satoshi Yoshino, Machida-shi (JP)

Correspondence Address: KANESAKA BERNER AND PARTNERS LLP, 1700 DIAGONAL RD, SUITE 310, ALEXANDRIA, VA, 22314-2848, US

(73) Assignee: KABUSHIKI KAISHA AUDIO-TECHNICA, Machida-shi (JP)

(21) Appl. No.: 12/003,267

(22) Filed: Dec. 21, 2007

(30) Foreign Application Priority Data
Dec. 28, 2006 (JP) 2006-354648

(51) Int. Cl. H04R 11/04

(52) U.S. Cl. 381/361

(57) ABSTRACT

Cavity resonance is prevented from being produced in a microphone case by strong electromagnetic waves of a cellular phone level in a boundary microphone provided with a flat microphone case having a relatively large internal space. In the boundary microphone including the microphone case 1 made up of a flat metallic base part 10 the upper surface of which is open and a metallic microphone cover 20 having a large number of openings (sound wave introduction holes), which is attached to the base part 10 so as to cover the upper surface of the base part 10, in which at least a microphone unit 31 and a circuit board 30 on which a predetermined electric circuit is formed are housed in the microphone case 1, the space in the microphone case 1 is filled with a filler (for example, a metallic wool material or a conductive sponge material) 50 having electric conductivity, permeability, and elasticity in combination.

### TECHNICAL FIELD

The present invention relates to a boundary microphone and, more particularly, to a technique for preventing the generation of noise caused by extraneous electromagnetic waves.

### BACKGROUND ART

A boundary microphone (on-surface sound pickup microphone) is also called a surface mount microphone because it is used by being installed on a table or floor surface in a TV studio, a conference room, or the like. As described in Patent Document 1 (Japanese Utility Model Registration No. 2515812), the boundary microphone uses a flat microphone case. One example thereof is explained by reference to the sectional view of FIG. 2 and the exploded sectional view of FIG. 3.

Referring to FIGS. 2 and 3, a microphone case 1 used for a boundary microphone is basically made up of two elements: a flat metallic base part 10 the upper surface side of which is open, and a metallic microphone cover 20 having a large number of openings (sound wave introduction holes), which is attached to the base part 10 so as to cover the upper surface of the base part 10.

Usually, the base part 10 is formed by casting such as zinc die casting, and as the microphone cover 20, a punched plate (perforated plate) is used. In place of the punched plate, a wire net member is sometimes used. The microphone cover 20 is screw-mounted onto the base part 10. It is screw-mounted at one point because screw-mounting at many points provides bad appearance.

Specifically, a screw insertion hole 21 is formed approximately in the center of the microphone cover 20, and a boss 11 having internal threads is erected on the base part 10 side, by which an externally threaded screw 22 for fixation is threadedly engaged with the boss 11 through the screw insertion hole 21 to fix the microphone cover 20 to the base part 10.

A shielded space is formed in the microphone case 1 by the base part 10 and the microphone cover 20, and in this space, a circuit board 30 on which a condenser microphone unit 31 is mounted is housed. Although not shown in the figures, on the circuit board 30, an impedance converter such as a field effect transistor (FET), a tone control circuit, an output circuit, and the like are also mounted. Also, a microphone cord 32 is connected to the circuit board 30. The microphone cord 32 is drawn out of the base part 10 via a cord bush 33.

The punched plate used for the microphone cover 20 is formed by, for example, an iron plate in which a large number of holes are formed. The punched plate is cut out into a predetermined shape, and thereafter is fabricated into an intended shape by a press. Because the punched plate is a perforated plate, a peripheral end face (cutting face) 20a thereof that is brought into contact with the base part 10 is uneven and serrated. On the other hand, the casting surface of the base part 10 is not smooth in the case where the base part 10 is formed by die casting. Therefore, the electrical connection between the base part 10 and the microphone cover 20 is point contact at many points.

Regarding the influence of electromagnetic waves, the interference due to electromagnetic waves of an ordinary VHF or UHF band used at broadcasting stations can be overcome sufficiently by the shield provided by the base part 10 and the microphone cover 20. However, in the field of microphone, as cellular phones have come into wide use in recent years, the influence of strong electromagnetic waves emitted from the cellular phone has posed a problem.

Specifically, when the cellular phone is used, considerably strong electromagnetic waves (for example, within the range of about several centimeters to several tens centimeters, a field intensity reaching tens of thousands times of field intensity produced in the city by commercial electric waves) are generated.

However, for the shield provided by the base part 10 and the microphone cover 20, since the electrical contact is point contact, the microphone cover 20 acts as an antenna when the above-described strong electromagnetic waves are applied, which sometimes results in the generation of noise.

To solve this problem, the applicant of the present invention has proposed, in Patent Document 2 (Japanese Patent Laid-Open No. 2005-333180), a technique in which a gasket 40 having both of elasticity and electric conductivity (a gasket in which the whole circumference of a core material having elasticity is covered with a conductive fiber) is held between the peripheral end face 20a of the microphone cover 20 and the base part 10.

According to the invention described in Patent Document 2, although the shield of the peripheral edge part of the microphone cover achieves an expected effect, the microphone cover is made of iron to secure a predetermined strength, and a portion in which the microphone cord is drawn out, an opening portion of a switch, not shown, and the like are not necessarily shielded completely, so that electromagnetic waves sometimes intrude into the microphone case from these portions.

For the boundary microphone, since the space in the microphone case is relatively large, if electromagnetic waves intrude, a cavity resonator is formed.

This is because the size of the space in the microphone case is very close to the wavelength of electromagnetic waves emitted from the cellular phone. The formation of cavity resonator generates noise.

Accordingly, an object of the present invention is to prevent cavity resonance from being produced in a microphone case by strong electromagnetic waves emitted from a cellular phone in a boundary microphone provided with a flat microphone case having a relatively large internal space.

### SUMMARY OF THE INVENTION

To achieve the above object, the present invention provides a boundary microphone including a microphone case made up of a flat metallic base part the upper surface of which is open and a metallic microphone cover having a large number of openings (sound wave introduction holes), which is attached to the base part so as to cover the upper surface of the base part, in which at least a microphone unit and a circuit board on which a predetermined electric circuit is formed are housed in the microphone case, wherein the space in the microphone case is filled with a filler having electric conductivity, permeability, and elasticity in combination.

As a further preferable mode, a metallic wool material or a conductive sponge material is preferably used as the filler.

Also, preferably, a gasket having both of elasticity and electric conductivity is further arranged between the peripheral end face of the microphone cover and the base part.

According to the present invention, since the space in the microphone case is filled with a filler (preferably, a metallic wool material or a conductive sponge material) having electric conductivity, permeability, and elasticity in combination, the electric field in the space in the microphone case is short-circuited, so that the occurrence of cavity resonance is prevented. Also, since the number of contact locations increases, the shield is strengthened.

### BRIEF DESCRIPTION OF THE DRAWINGS

FIG. 1 is a sectional view showing an embodiment of a boundary microphone in accordance with the present invention;

FIG. 2 is a sectional of a conventional general boundary microphone; and

FIG. 3 is an exploded sectional view of the boundary microphone shown in FIG. 2.

### DETAILED DESCRIPTION

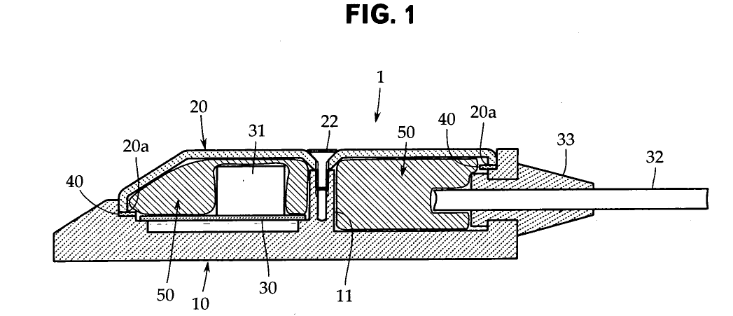

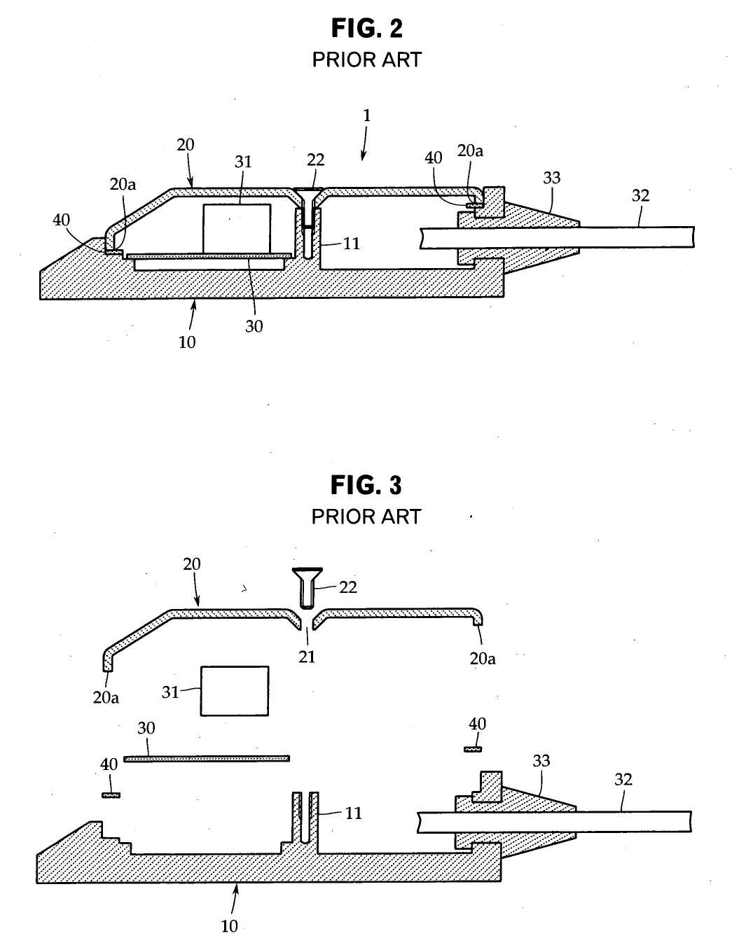

An embodiment of the present invention will now be described by reference to FIG. 1. The present invention is not limited to this embodiment. FIG. 1 is a sectional view showing an embodiment of a boundary microphone in accordance with the present invention. In the explanation of this embodiment, the same reference numerals are applied to elements that are the same as those in the conventional example explained by reference to FIGS. 2 and 3.

As shown in FIG. 1, in the boundary microphone in accordance with the present invention as well, a microphone case 1 may be formed by two elements: a flat metallic base part 10 the upper surface side of which is open, and a metallic microphone cover 20 having a large number of openings (sound wave introduction holes), which is attached to the base part 10 so as to cover the upper surface of the base part 10.

Usually, the base part 10 is formed by casting such as zinc die casting. However, as the base part 10, a press molded product formed of a metal other than zinc may be used. Also, as the microphone cover 20, a punched plate (perforated plate) made of iron etc. is used. However, in place of the punched plate, a wire net member may be used. Also, the microphone cover 20 may be painted.

In this example as well, the microphone cover 20 is screw-mounted on the base part 10. From the viewpoint of appearance (design), one-point mounting using a fixation screw 22 and a boss 11 as in the conventional example is preferable. However, since the mounting method is not an essential portion of the present invention, screw-mounting may be performed at many points. Also, in some case, the microphone cover 20 may be fixed to the base part 10 by a method other than screw-mounting.

In the space in the microphone case 1 formed by the base part 10 and the microphone cover 20, a circuit board 30 and a condenser microphone unit 31 are housed. The condenser microphone unit 31 may be housed in the microphone case 1 in the state where the circuit board 30 is mounted thereon as shown in FIG. 1, or may be housed separately from the circuit board 30.

Although not shown in the figure, on the circuit board 30, an impedance converter, a tone control circuit, an output circuit, and the like may be mounted. Also, a microphone cord 32 is connected to the circuit board 30. The microphone cord 32 is drawn out of the base part 10 via a cord bush 33.

The microphone cover 20 is cut out of a punched plate (or a net wire member) into a predetermined shape, and thereafter is fabricated into an intended shape by a press. Therefore, a peripheral end face (cutting face) 20a of the microphone cover 20, which is brought into contact with the base part 10, is uneven and serrated. On the other hand, the casting surface of the base part 10 is not smooth in the case where the base part 10 is formed by die casting.

Therefore, the electrical connection between the base part 10 and the microphone cover 20 is in a state of point contact at many points. Even if the casting surface of the base part 10 is smooth, since the peripheral end face 20a of the microphone cover 20 is uneven and serrated, the electrical connection between the base part 10 and the microphone cover 20 is point contact at many points.

In such a point contact state, if, for example, a cellular phone is used near the microphone case 1, and thereby strong electromagnetic waves are applied to the microphone case 1, the microphone cover 20 itself functions as an antenna and receives the electromagnetic waves. The received electromagnetic waves are detected by the impedance converter, by which noise is sometimes generated.

To prevent the generation of noise, in this embodiment, a gasket 40 having both of elasticity and electric conductivity is arranged between the peripheral end face 20a of the microphone cover 20 and the base part 10. The gasket 40 is preferably arranged over the whole of the peripheral end face 20a of the microphone cover 20. However, the gasket 40 may be arranged partially at several locations.

Although not shown in the figure, as the gasket 40, a gasket in which the whole circumference of a core material having elasticity, such as sponge or rubber, is covered with a conductive fiber (conductive fabric) is preferably used. As the gasket of this type, for example, Soft Shield 5000 (trade name) manufactured by Taiyo Wire Cloth Co., Ltd. is available.

By holding the gasket 40 between the peripheral end face 20a of the microphone cover 20 and the base part 10, the microphone cover 20 and the base part 10 are electrically connected to each other with a low impedance, so that a shielded space effective against strong electromagnetic waves with high frequency is provided in the microphone case 1.

Also, depending on the dimensional errors of the base part 10 and the microphone cover 20, unsteadiness can also be absorbed by the gasket 40. Further, even if the microphone cover 20 is attached and detached repeatedly to exchange the condenser microphone unit 31, the initial shielding performance can be maintained.

Even if the microphone case 1 is configured as described above, the microphone cover 20 is made of iron to secure a predetermined strength, and a portion in which the microphone cord 32 is drawn out, an opening portion of a switch, not shown, and the like are not necessarily shielded completely, so that strong electromagnetic waves emitted from, for example, a cellular phone sometimes intrude into the microphone case 1 from these portions. If so, a cavity resonator causing noise to be generated may be formed in the microphone case 1.

To prevent such a phenomenon, in the present invention, the space in the microphone case 1 is filled with a filler 50 having electric conductivity, permeability, and elasticity in combination. According to this configuration, since the electric field in the space in the microphone case 1 is short-circuited, the occurrence of cavity resonance is prevented. Also, since the number of contact locations increases, the shield is strengthened.

As the filler 50 of this kind, a metallic wool material or a conductive sponge material is preferable. From the viewpoint of mass production, the conductive sponge material is preferably employed. The conductive sponge material is commercially available from, for example, ESD EMI Engineering Corporation.

The present application is based on, and claims priority from, Japanese Application Serial Number JP2006-354648, filed Dec. 28, 2006, the disclosure of which is hereby incorporated by reference herein in its entirety.

1. A boundary microphone comprising a microphone case made up of a flat metallic base part the upper surface of which is open and a metallic microphone cover having a large number of openings (sound wave introduction holes), which is attached to the base part so as to cover the upper surface of the base part, in which at least a microphone unit and a circuit board on which a predetermined electric circuit is formed are housed in the microphone case,
wherein the space in the microphone case is filled with a filler having electric conductivity, permeability, and elasticity in combination.

2. The boundary microphone according to claim 1, wherein as the filler, a metallic wool material or a conductive sponge material is used.

3. The boundary microphone according to claim 1, wherein a gasket having both of elasticity and electric conductivity is further arranged between the peripheral end face of the microphone cover and the base part.
